(19) United States
(12) Patent Application Publication
(10) Pub. No.: US 2014/0222724 A1
(43) Pub. Date: Aug. 7, 2014

(54) GENERATION OF LOG-LINEAR MODELS USING L-1 REGULARIZATION

(71) Applicant: MICROSOFT CORPORATION, Redmond, WA (US)

(72) Inventors: Jianfeng Gao, Woodinville, WA (US); Xuedong Huang, Bellevue, WA (US); Zhenghao Wang, Bellevue, WA (US); Yunhong Zhou, Bellevue, WA (US)

(73) Assignee: MICROSOFT CORPORATION, Redmond, WA (US)

(21) Appl. No.: 13/757,785

(22) Filed: Feb. 2, 2013

(51) Int. Cl. G06N 99/00

(52) U.S. Cl. CPC G06N 99/005
USPC 706/12

(57) ABSTRACT

A log-linear model may be trained using a modified version of an original limited-memory Broyden-Fletcher-Goldfarb-Shanno (L-BFGS) algorithm. The modified version may be based on modifying the original L-BFGS algorithm using a single map-reduce implementation. In another aspect, a sparse log-linear model may be accessed. The sparse log-linear model may be trained with L1-regularization, based on data indicating past user ad selection behaviors. A probability of a user selection of an ad may be determined based on the sparse log-linear model.

### BACKGROUND

Developers of software systems are increasingly using very large databases of collected information to train models for many different types of applications. For example, there may be a desire to generate one or more models based on very large databases of information obtained via web crawlers, or via user interaction with various applications such as search engines and/or marketing/advertising sites. For example, implementation issues may arise with regard to scaling of such large amounts of data.

Users are increasingly using electronic devices to obtain information for many aspects of business, research, and daily life. For example, vendors have also become increasingly interested in providing advertisements (ads) associated with the vendors' goods or services to users, as the users investigate various items. For example, an automobile vendor may be interested in providing ads regarding the vendors' current automobile specials, if it is determined that the user is initiating one or more queries related to automobiles. For example, such vendors may be willing to pay search engine providers for delivery of their ads to prospective interested users. Thus, vendors and user content providers may desire accuracy in techniques for predicting users' selections (e.g., via clicks) of online advertising, for example, as such predictions may affect revenue per 1,000 impressions (RPM).

### SUMMARY

According to one general aspect, a system may include a device that includes at least one processor. The device may include an advertisement (ad) prediction engine that may include a model access component configured to access a sparse log-linear model trained with L1-regularization, based on data indicating past user ad selection behaviors. A prediction determination component may be configured to determine a probability of a user selection of an ad based on the sparse log-linear model.

According to another aspect, a log-linear model may be trained using a modified version of an original limited-memory Broyden-Fletcher-Goldfarb-Shanno (L-BFGS) algorithm, the modified version based on modifying the original L-BFGS algorithm using a single map-reduce implementation.

According to another aspect, a computer program product tangibly embodied on a computer-readable storage medium may include executable code that may cause at least one data processing apparatus to obtain a user query. Further, the at least one data processing apparatus may determine, via a device processor, a probability of a user selection of at least one advertisement (ad) based on the user query and a sparse log-linear model trained with L1-regularization.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. The details of one or more implementations are set forth in the accompanying drawings and the description below. Other features will be apparent from the description and drawings, and from the claims.

### DRAWINGS

FIG. 1 is a block diagram of an example system for predicting user selections of advertisements.

FIG. 2 illustrates example features that may be used for an example training database.

FIG. 3 is a block diagram of an example architecture for the system of FIG. 1.

FIGS. 4a-4b are a flowchart illustrating example operations of the system of FIG. 1.

FIGS. 5a-5b are a flowchart illustrating example operations of the system of FIG. 1.

FIG. 6 is a flowchart illustrating example operations of the system of FIG. 1.

### DETAILED DESCRIPTION

I. Introduction

Many current ad prediction systems may determine the predictions based on large amounts of past user selection data (e.g., user “click” data) stored in system log files. For example, developers of such prediction systems may wish to develop models that are efficient at runtime, but which may be trained on substantially large amounts of data with substantially large amounts of features.

For example, prediction models may be learned from substantially large amounts of past data using, at least in part, stochastic gradient descent (SGD) based approaches, as discussed, for example, by Chris Burges, et al., “Learning to Rank using Gradient Descent,” In Proceedings of the 22nd International Conference on Machine Learning, Bonn, Germany, 2005, pp. 89-96.

In accordance with example techniques discussed herein, an example ad prediction system may utilize Structured Computations Optimized for Parallel Execution (SCOPE), for example, as a map-reduced programming model, for learning sparse log-linear models for ad prediction. For example, Ronnie Chaiken, et al., “SCOPE: Easy and Efficient Parallel Processing of Massive Data Sets,” In Proceedings of the VLDB Endowment, Vol. 1, Issue 2, August 2008, pp. 1265-1276, provides a general discussion of SCOPE.

As discussed herein, ad prediction may involve a binary classification problem. For example, given a pair that includes a query and an ad, (Q, A), and its context information (e.g., user id, query-ad match type, location etc.), an example ad prediction model may predict how likely the ad will be selected (e.g., clicked) by a user who issued the query.

As discussed further herein, the ad selection prediction may be achieved based on an example log-linear model which captures (Q, A), and its context information may be captured using large amounts of features. As further discussed herein, an example sparse log-linear model may be trained using an example Orthant-Wise Limited-memory Quasi-Newton (OWL-QN) algorithm. For example, OWL-QN algorithms are discussed by Galen Andrew, et al., “Scalable Training of L₁-Regularized Log-Linear Models,” In Proceedings of the 24th International Conference on Machine learning, (2007), pp. 33-40. As further discussed herein, an example OWL-QN technique may be implemented for a map-reduced system, for example, using SCOPE.

II. Example Operating Environment

Features discussed herein are provided as example embodiments that may be implemented in many different ways that may be understood by one of skill in the art of data processing, without departing from the spirit of the discussion herein. Such features are to be construed only as example embodiment features, and are not intended to be construed as limiting to only those detailed descriptions.

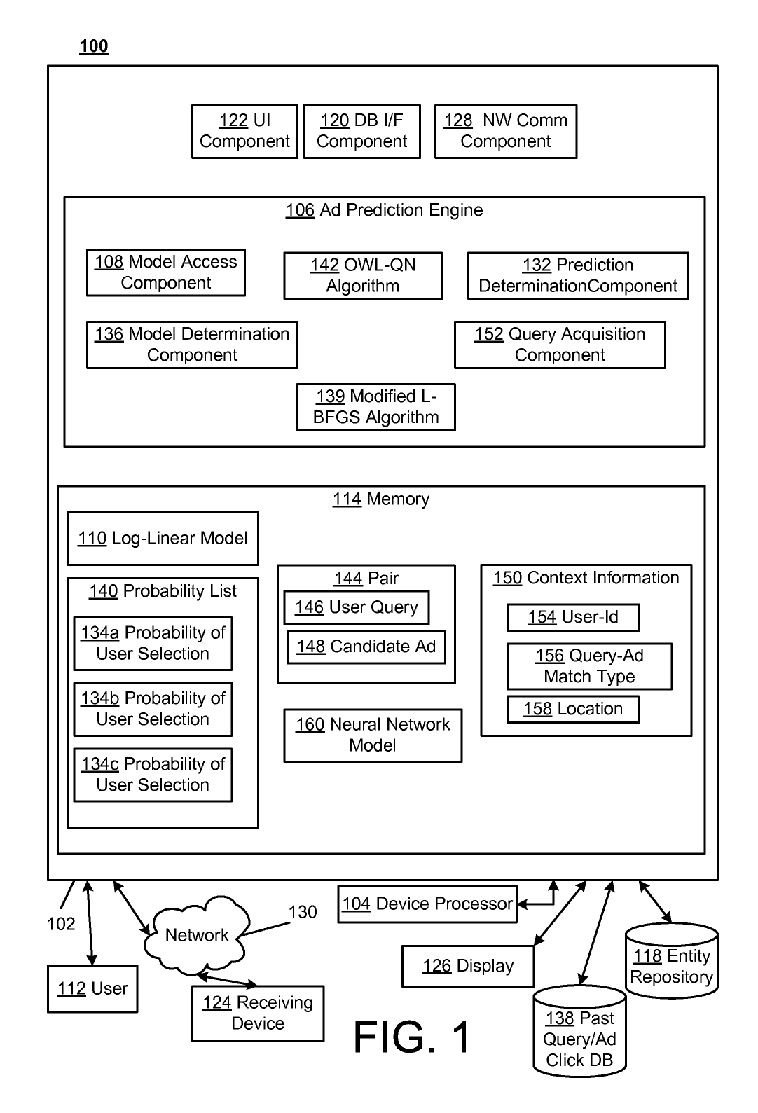

As further discussed herein, FIG. 1 is a block diagram of a system 100 for predicting user selections of advertisements. As shown in FIG. 1, a system 100 may include a device 102 that includes at least one processor 104. The device 102 includes an advertisement (ad) prediction engine 106 that may include a model access component 108 that may be configured to access a sparse log-linear model 110 trained with L1-regularization, based on data indicating past user ad selection behaviors. For example, the sparse log-linear linear model 110 may be stored in a memory 114.

For example, the ad prediction engine 106, or one or more portions thereof, may include executable instructions that may be stored on a tangible computer-readable storage medium, as discussed below. For example, the computer-readable storage medium may include any number of storage devices, and any number of storage media types, including distributed devices.

For example, an entity repository 118 may include one or more databases, and may be accessed via a database interface component 120. One skilled in the art of data processing will appreciate that there are many techniques for storing repository information discussed herein, such as various types of database configurations (e.g., relational databases, hierarchical databases, distributed databases) and non-database configurations.

According to an example embodiment, the device 102 may include the memory 114 that may store the sparse log-linear linear model 110. In this context, a “memory” may include a single memory device or multiple memory devices configured to store data and/or instructions. Further, the memory 114 may span multiple distributed storage devices.

According to an example embodiment, a user interface component 122 may manage communications between a device user 112 and the ad prediction engine 106. The device 102 may be associated with a receiving device 124 and a display 126, and other input/output devices. For example, the display 126 may be configured to communicate with the device 102, via internal device bus communications, or via at least one network connection.

According to example embodiments, the display 126 may be implemented as a flat screen display, a print form of display, a two-dimensional display, a three-dimensional display, a static display, a moving display, sensory displays such as tactile output, audio output, and any other form of output for communicating with a user (e.g., the device user 112).

According to an example embodiment, the system 100 may include a network communication component 128 that may manage network communication between the ad prediction engine 106 and other entities that may communicate with the ad prediction engine 106 via at least one network 130. For example, the network 130 may include at least one of the Internet, at least one wireless network, or at least one wired network. For example, the network 130 may include a cellular network, a radio network, or any type of network that may support transmission of data for the ad prediction engine 106. For example, the network communication component 128 may manage network communications between the ad prediction engine 106 and the receiving device 124. For example, the network communication component 128 may manage network communication between the user interface component 122 and the receiving device 124.

In this context, a “processor” may include a single processor or multiple processors configured to process instructions associated with a processing system. A processor may thus include one or more processors processing instructions in parallel and/or in a distributed manner. Although the processor 104 is depicted as external to the ad prediction engine 106 in FIG. 1, one skilled in the art of data processing will appreciate that the processor 104 may be implemented as a single component, and/or as distributed units which may be located internally or externally to the ad prediction engine 106, and/or any of its elements.

For example, the system 100 may include one or more processors 104. For example, the system 100 may include at least one tangible computer-readable storage medium storing instructions executable by the one or more processors 104, the executable instructions configured to cause at least one data processing apparatus to perform operations associated with various example components included in the system 100, as discussed herein. For example, the one or more processors 104 may be included in the at least one data processing apparatus. One skilled in the art of data processing will understand that there are many configurations of processors and data processing apparatuses that may be configured in accordance with the discussion herein, without departing from the spirit of such discussion. For example, the data processing apparatus may include a mobile device.

In this context, a “component” may refer to instructions or hardware that may be configured to perform certain operations. Such instructions may be included within component groups of instructions, or may be distributed over more than one group. For example, some instructions associated with operations of a first component may be included in a group of instructions associated with operations of a second component (or more components).

The ad prediction engine 106 may include a prediction determination component 132 configured to determine a probability 134a, 134b, 134c of a user selection of an ad based on the sparse log-linear linear model 110.

For example, a model determination component 136 may be configured to determine the sparse log-linear linear model 110 trained with L1-regularization, based on data indicating past user ad selection behaviors based on a database 138 that includes information associated with past user queries and respective ads that were selected, in association with the respective past user queries.

Log-linear models, which may also be referred to as “logistic regression models”, are widely used for binary classification. An example log-linear model may involve learning a mapping from inputs xεX to outputs yεY. In accordance with example techniques discussed herein, for an ad prediction task, x may represent a query-ad pair and its context information (Q, A), and y may represent a binary value (e.g., with 1 indicating a click and 0 indicating no click). The probability of a user selection (e.g., a user click), given a pair (Q, A), may be modeled as Equation (1):

$$P ( y \vert x ) = \frac{exp ( Φ ( x , y ) \cdot w )}{1 + exp ( Φ ( x , y ) \cdot w )} \qquad ( 1 )$$

where φ: X×Y [symbol] ^{D} represents a feature mapping function that maps each (x, y) to a vector of feature values, and wε [symbol] ^{D} represents a model parameter vector which assigns a real-valued weight to each feature.

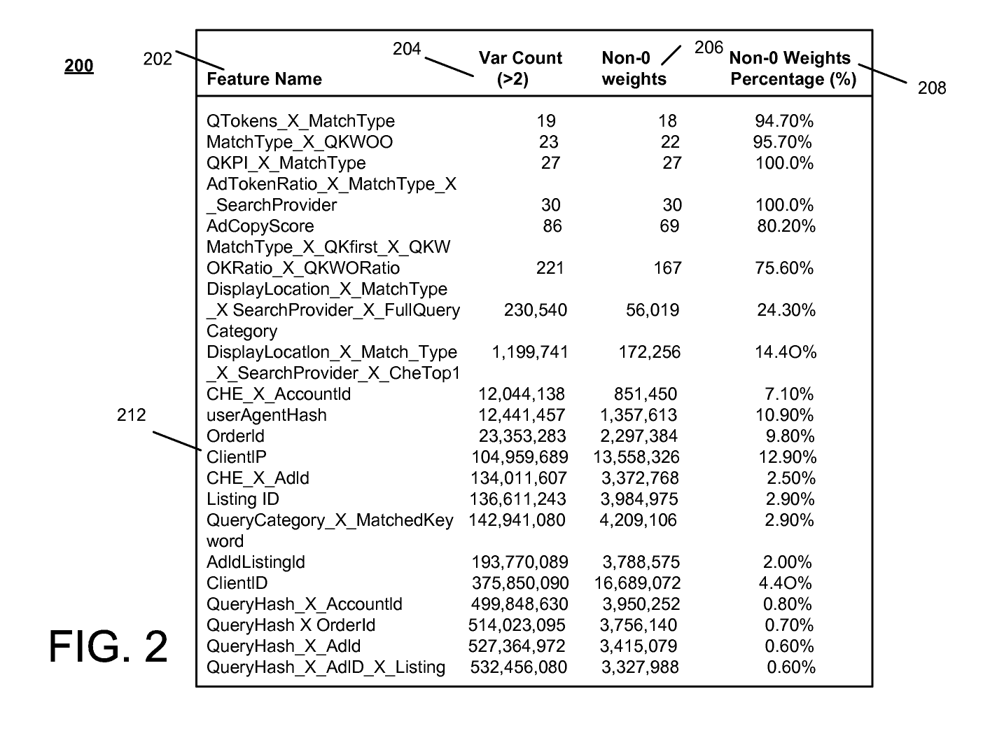

For example, FIG. 2 illustrates example features 202 that may be used for an example training database, with each respective feature's count 204 of different values for each respective feature 202. For each different feature, a feature weight w may be assigned. For example, there may be billions of parameters (e.g., feature weights) to be estimated. For example, some databases may include 15 billion different features in 28-day log files.

For example, in order to achieve a more manageable runtime prediction, an example model may be trained such that most feature weights are assigned a value of zero in the resulting model, as indicated by values listed in a non-0 weights column 306 and a non-zero weights percentage column 208. For example, as shown in FIG. 2, a feature indicated as “ClientIP” 210 is shown as having 104,959,689 different values, with 13,558,326 resulting non-zero weights, or a resulting 12.90% percentage of non-zero weights.

For example, the model determination component 136 may be configured to determine the sparse log-linear model 110 based on initiating training of the sparse log-linear model 110 using a modified limited-memory Broyden-Fletcher-Goldfarb-Shanno (L-BFGS) algorithm 139, wherein the L-BFGS algorithm 139 is modified based on modifying an original version of the L-BFGS algorithm using a single map-reduce implementation.

For example, the prediction determination component 132 may be configured to determine a list 140 of probabilities 134a, 134b, 134c of user selections of ads based on the sparse log-linear linear model 110.

For example, the model determination component 136 may be configured to initiate training of the sparse log-linear linear model 110 based on an Orthant-Wise Limited-memory Quasi-Newton (OWL-QN) algorithm 142 for L-1 regularized objectives.

As discussed herein, Equation (1) above may be learned from training samples (x, y) which record user selection information (e.g., user click information), which may be extracted from past log files. In accordance with one aspect, an example OWL-QN algorithm, as discussed by Galen Andrew, et al., “Scalable Training of L₁-Regularized Log-Linear Models,” In Proceedings of the 24th International Conference on Machine learning, (2007), pp. 33-40, may be used.

However, one skilled in the art of data processing will understand that other algorithms may be used, without departing from the spirit of the discussion herein. According to an example embodiment, an L1-regularized objective may be used to estimate the model parameters so that the resulting model assigns only a small portion of features a non-zero weight.

For example, an estimator (based on OWL-QN) may choose w to minimize a sum of the empirical loss on the training samples and an L1-regularization term:

\hat{w}=arg min_{w}{L(w)+R(w)} (2)

where a loss term L(w) indicates a negative conditional log-likelihood of the training data, which may be indicated as L(w)=−Σᵢ₌₁ⁿ log P(yᵢ|xᵢ), where P (y|x) may be defined as in Equation (1). Further, the L1-regularization term may be indicated in accordance with R(w)=αΣⱼ|wⱼ| where α is a parameter that controls the amount of regularization, optimized on held-out data. For example, L1 regularization may lead to sparse solutions in which many feature weights are exactly zero, and thus it may be a desirable candidate when feature selection is desirable, as in ad prediction problems.

Optimizing the L1-regularized objective function involves considerations that its gradient is discontinuous whenever some parameter equals zero. In accordance with example techniques discussed herein, the orthant-wise limited-memory quasi-Newton algorithm (OWL-QN), which is a modification of a limited-memory Broyden-Fletcher-Goldfarb-Shanno (L-BFGS) algorithm that allows it to effectively handle the discontinuity of the gradient (as discussed in Galen Andrew, et al., “Scalable Training of L₁-Regularized Log-Linear Models,” In Proceedings of the 24th International Conference on Machine learning, (2007), pp. 33-40), may be used.

For example, a quasi-Newton method such as L-BFGS may use first order information at each iterate to build an approximation to the Hessian matrix, H, thus modeling the local curvature of the function. At each step, a search direction is chosen by minimizing a quadratic approximation to the function:

$$Q ( x ) = \frac{1}{2} {( x - {x}_{0} )}^{′} H ( x - {x}_{0} ) + {g}_{0}^{′} ( x - {x}_{0} ) \qquad ( 3 )$$

where x₀ represents the current iterate, and g₀ represents the function gradient at x₀. If H is positive definite, the minimizing value of x may be determined analytically in accordance with:

x*=x₀−H⁻¹g₀ (4)

L-BFGS may maintain vectors of the change in gradient gₖ−gₖ₋₁ from the most recent iterations, and may use them to construct an estimate of the inverse HessianH⁻¹. Furthermore, it may do so in such a way that H⁻¹g₀ may be determined without expanding out the full matrix, which may be unmanageably large. The computation may involve a number of operations linear in the number of variables.

OWL-QN is based on an observation that when restricted to a single orthant, the L1 regularizer is differentiable, and is a linear function of w. Thus, as long as each coordinate of any two consecutive search points does not pass through zero, R(w) does not contribute to the curvature of the function on the segment joining them. Therefore, L-BFGS may be used to approximate the Hessian of L(w) alone, and L-BFGS may be used to build an approximation to the full regularized objective that is valid on a given orthant. To ensure that the next point is in the valid region, during the line search, each point may be projected back onto the chosen orthant. This projection involves zeroing-out any coordinates that change sign. Thus, it is possible for a variable to change sign in two iterations, by moving from a negative value to zero, and on the next iteration moving from zero to a positive value. At each iteration, the orthant that is selected may be the orthant including the current point and into which the direction giving the greatest local rate of function decrease points.

For example, this algorithm may reach convergence in fewer iterations than standard L-BFGS involves on the analogous L2-regularized objective (which translates to less training time, since the time per iteration is negligibly higher, and total time is dominated by function evaluations).

For example, the model determination component 136 may be configured to initiate training of the sparse log-linear linear model 110 based on a map-reduced programming model of the OWL-QN algorithm 142.

For example, a Structured Computations Optimized for Parallel Execution (SCOPE) model, as discussed in Ronnie Chaiken, et al., “SCOPE: Easy and Efficient Parallel Processing of Massive Data Sets,” In Proceedings of the VLDB Endowment, Vol. 1, Issue 2, August 2008, pp. 1265-1276, may be used to develop the large-scale log linear model trainer. For example, the SCOPE scripting language resembles Structured Query Language (SQL), and also supports C# expressions, such that users may plug-in customized C# classes. For example, SCOPE supports writing a program using a series of simple data transformations so that users may write a script to process data in a serial manner without dealing with parallelism programming issues, while the SCOPE compiler and optimizer may translate the script into a parallel execution plan.

As discussed further below, two example techniques may be used to ease some limitations of a map-reduced system such as SCOPE, and which may scale the estimator, for example, to tens of billions of training samples and billions of model parameters (i.e., feature weights). For example, a first technique may modify an original L-BFGS two-loop recursion algorithm, described as Algorithm 9.1 in Nocedal, J., and Wright, S. J., Numerical Optimization, Springer (1999), pp. 224-225, to handle high-dimensional vectors more efficiently in a map-reduce system.

For example, a second technique may advantageously determine the gradient vector where the dimensionality of the vector is so large that the vector may not be stored in the memory of a single machine.

A goal of Orthant-Wise Limited-memory Quasi-Newton (OWL-QN) algorithm for L1-regularized objectives is to minimize the following function:

ƒ(w)=L(w)+C₁∥w∥₁, (5)

where L(w) is a differentiable convex loss function, and C₁≧0 is an L1 regularization constant. L1 regularization is not differentiable at orthant boundaries. OWL-QN adapts a quasi-Newton descend algorithm such as L-BFGS to work with L1 regularization. For example, “OwScope” may refer to an implementation of the algorithm in SCOPE, which may be able to scale the algorithm to tens of billions of training samples as well as billions of weight variables.

A potential concern using L-BFGS two-loop recursion may involve a high dimensionality of the weight/feature vectors (e.g., billions of weight variables). For example, pClick models may be trained using OwScope with 3.2 billion features and M=14. For example, the L-BFGS algorithm may involve memory usage in a range of 3.2 billion×14×2=89.6 billion floating-point numbers. For example, if single-precision floating point numbers are used, 89.6×4=358.4 GB memory may be used to store L-BFGS state.

For example, a runtime system may provide no more than 6 GB of memory per processing node, and thus, the L-BFGS loops may be partitioned (e.g., map-reduced).

For example, an original L-BFGS two-loop recursion for estimating the descending direction for quasi-Newton iteration i+1 may be indicated as shown in Algorithm 1:

Algorithm 1
Original L-BFGS Two-Loop Recursion

1 d = ∇f(wᵢ);
2 for j= [i ... i − m)
3 αⱼ = sⱼ · d/sᵢ · yᵢ;
4 d = d − αⱼyⱼ;
5 d = ( sᵢ · yᵢ/yᵢ · yᵢ) d;
6 for j= (i − m ... i]
7 β = yⱼ · d/sᵢ · yᵢ ;
8 d = d + (αⱼ − β)sⱼ;

As shown in Algorithm 1, in the loops, wᵢ represents the weight vector after iteration i; sᵢ=wᵢ−wᵢ₋₁ and yᵢ=∇ƒ(wᵢ)−∇ƒ(wᵢ₋₁) represent the vectors in the L-BFGS memory (e.g., weight vector delta and gradient vector delta); d represents the direction.

For example, a map-reduce may be applied to every iteration of the above two loops. However, this may result in 2m map-reduces per quasi-Newton iteration, or 2Nm over N quasi-Newton iterations, resulting in a job plan that may become overly complicated for a map-reduce system execution engine, and the map-reduce overhead may become so large that it dominates the training time.

For example, an original L-BFGS two-loop recursion in an original high-dimension space may be transformed to a similar recursion but in a substantially smaller (2m+1)-dimension space. For example, such a transformation may be achieved by a linear transformation to the (2m+1)-dimension linear space composed from the following (non-orthogonal) (2m+1) base vectors:

$${b}_{1} = {s}_{i - m + 1} \\ ⋮ \\ {b}_{m} = {s}_{i} \\ {b}_{m + 1} = {y}_{i - m + 1} \\ ⋮ \\ {b}_{2 m} = {y}_{i} \\ {b}_{2 m + 1} = ∇ f ( {w}_{i} ) \qquad ( 6 )$$

A (2m+1)-dimension vector δ may represent d:

d=Σₖ₌₁^{2m+1}δₖbₖ (7)

The L-BFGS 2-loop recursion discussed above becomes the following, as shown in Algorithm 2, in terms of δₖ:

Algorithm 2
Revised L-BFGS Two-Loop Recursion in (2m + 1)-dimensional Space

1 L-BFGS-δₖ;
2 for k= [i ... 2m +1]
3 δₖ = k ≦ 2m? 0: 1;
4 for k= [m ... 1]
5 αᵢ₋ₘ₊ₖ = bₖ · d/bₘ · b₂ₘ = Σₗ₌₁^{2m+1} δₗbₖ · bₗ/bₘ · b₂ₘ;
6 δₘ₊ₖ = δₘ₊ₖ− αᵢ₋ₘ₊ₖ;
7 for k= [1... 2m+1]
8 δₖ = (bₖ · b₂ₘ/b₂ₘ · b₂ₘ )δₖ ;
9 for k= [1... m]
10 β = bₘ₊ₖ · d/bₘ · b₂ₘ = Σₗ₌₁^{2m+1} δₗbₘ₊ₖ · bₗ/bₘ · b₂ₘ;
11 δₖ = δₖ+ (αᵢ₋ₘ₊ₖ − β);

For example, the original L-BFGS loops may be implemented by the following three steps:

Single Map-Reduce L-BFGS:
Calculate the (2m+1)×(2m+1) dot product matrix bₖ·bₗ for k, l=[1 . . . 2m+1]
Run L-BFGS-δₖ loops to get the (2m+1)-dimension vector δₖ
Use d=Σₗ₌₁^{2m+1}δₖbₖ to obtain the output d of the original L-BFGS loops

For example, a single map-reduce may be used in the first step to calculate the matrix of all dot products between the (2m+1) base vectors. The L-BFGS-δₖ loops may then be performed sequentially. Finally, the substantially smaller (2m+1)-dimension vector δₖ may be mapped out to compute the original d of much higher dimensions.

The original L-BFGS loops discussed above may involve ˜4mD multiplications, where D is the dimension size of d and the other vectors. In comparison, the L-BFGS-δₖ loops discussed above may involve negligible ˜8m² multiplications and may not involve any parallelization. The first step in the single Map-Reduce L-BFGS above may involve ˜4m²D multiplications. However, if the dot matrix is saved across iterations, older dot products may be reused, and 2m new dot products may be calculated, involving ˜2mD multiplications. Saving the dot matrix only involves a negligible ˜4m² floating point numbers. The third step in the single Map-Reduce L-BFGS may involve requires another ˜2mD multiplications. Thus, altogether, the single Map-Reduce L-BFGS may involve ˜4mD multiplications, but virtually all the multiplications except for negligibly few (˜8m²) may be mapped out in two map operators.

In practice, after adopting the single Map-Reduce L-BFGS, the L-BFGS loops are no longer the bottleneck for scalability, and its run-time cost may become a substantially smaller portion of the overall cost, even for a large m and D such as m=14 and D=3.2×10⁹.

At every quasi-Newton iteration, both the objective function value and the gradient vector may be determined. For example, the training samples may be partitioned into P partitions. For example, the object function value and gradient vector contribution for each partition may then be determined, in accordance with:

$$Val , Grad from {Partition}_{1} = ( {val}_{1} , [ {partial}_{11} , {partial}_{12} , … , {partial}_{1 D} ] )$$

$$Val , Grad from {Partition}_{2} = ( {val}_{2} , [ {partial}_{21} , {partial}_{22} , … , {partial}_{2 D} ] )$$

$$…$$

$$Val , Grad from {Partition}_{P} = ( {val}_{P} , [ {partial}_{P 1} , {partial}_{P 2} , … , {partial}_{PD} ] )$$

For example, the value and gradient vector may then be aggregated afterwards. This example approach may involve adequate memory to store the partial gradient vector, which is a full vector that may not fit in an example 6 GB memory limit, as may be imposed by an example runtime.

This issue may be resolved by outputting the gradient vector as calculated by each partition of the training samples in sparse format, and then performing another aggregation step to sum them up. For example, the gradient contribution from every training sample may be returned as:

$$Grad from {samp}_{1} = [ ( {dim}_{11} , {partial}_{11} ) , ( {dim}_{12} , {partial}_{12} ) , … ( {dim}_{1 d\_ 1} , {partial}_{1 d\_ 1} ] )$$

$$Grad from {samp}_{2} = [ ( {dim}_{21} , {partial}_{21} ) , ( {dim}_{22} , {partial}_{22} ) , … ( {dim}_{2 d\_ 2} , {partial}_{2 d\_ 2} ] )$$

$$…$$

$$Grad from {samp}_{n} = [ ( {dim}_{n 1} , {partial}_{n 1} ) , ( {dim}_{n 2} , {partial}_{n 2} ) , … ( {dim}_{n d\_ n} , {partial}_{n d\_ n} ] )$$

For example, the contribution determination may be parallelized using a Reducer/Combiner.

For example, an output rowset may be represented as a union of all (dim, partial) pairs. An example technique may then partition on dim and sum up partials. Such an example technique may involve no memory storage for the gradient vector, but may incur substantial I/O between the Combiner and the aggregator following it. For example, a hybrid approach may be used to balance memory usage and input/output (I/O) between runtime system vertices.

For example, there may exist a natural biased distribution of feature dimensions. For example, a head query may be more popular than a tail query. Thus, the gradient vector from every partition may have different density along its dimensions.

For example, during a preparation step, the occurrence count of every feature dimension may be obtained. For example, the feature dimensions may be sorted based on their occurrence counts. For example, this may provide an indication of density among different dimensions, indicated as dense around the high-occurrence dimensions and sparse around the low-occurrence dimensions.

For example, dimensions may be divided into three regions, and may be handled differently, indicated as:
Dense. The gradient vector along dense dimensions may be encoded in dense format, and every combiner partition may pre-aggregate the partial derivatives over all samples before sending it to an example downstream aggregator.
Medium-density. The gradient vector along medium-density dimensions may be encoded in sparse format. However, every combiner partition may aggregate the partial derivatives over all samples before sending it to the downstream aggregator.
Sparse. The gradient vector along sparse dimensions may be encoded in sparse format. In addition, every combiner partition may not aggregate the partial derivatives over all samples before sending it to the downstream aggregator.

With the example flexible hybrid technique discussed above, a full dense gradient vector may not be stored in memory, which may cap at 1.5 billion dimensions due to an example 6 GB limit: 1.5 billion×4 bytes=6 GB. For example, this may enable OwScope to scale up to substantially higher dimensions.

For example, relating to the system 100, the prediction determination component 132 may be configured to determine the probability 134a, 134b, 134c of a user selection of the ad based on the sparse log-linear linear model 110, and based on a pair 144 that includes a user query 146 and one or more candidate ads 148, and on context information 150 associated with the pair 144. For example, user queries may be obtained via a query acquisition component 152.

For example, the context information 150 may include one or more of a user identifier (user-id) 154, a query-ad match type 156, or a location 158. For example, the context information 150 may include one or more of dates, times, and/or personal information. One skilled in the art of data processing will understand that many types of information, without departing from the spirit of the discussion herein.

For example, the prediction determination component 132 may be configured to determine the list 140 of probabilities of user selections of ads based on a hybrid system that combines the obtained sparse log-linear linear model 110 and another ranking model.

For example, the prediction determination component 132 may be configured to determine the list 140 of probabilities of user selections of ads based on a hybrid system that combines the sparse log-linear linear model 110 and a neural network model 160.

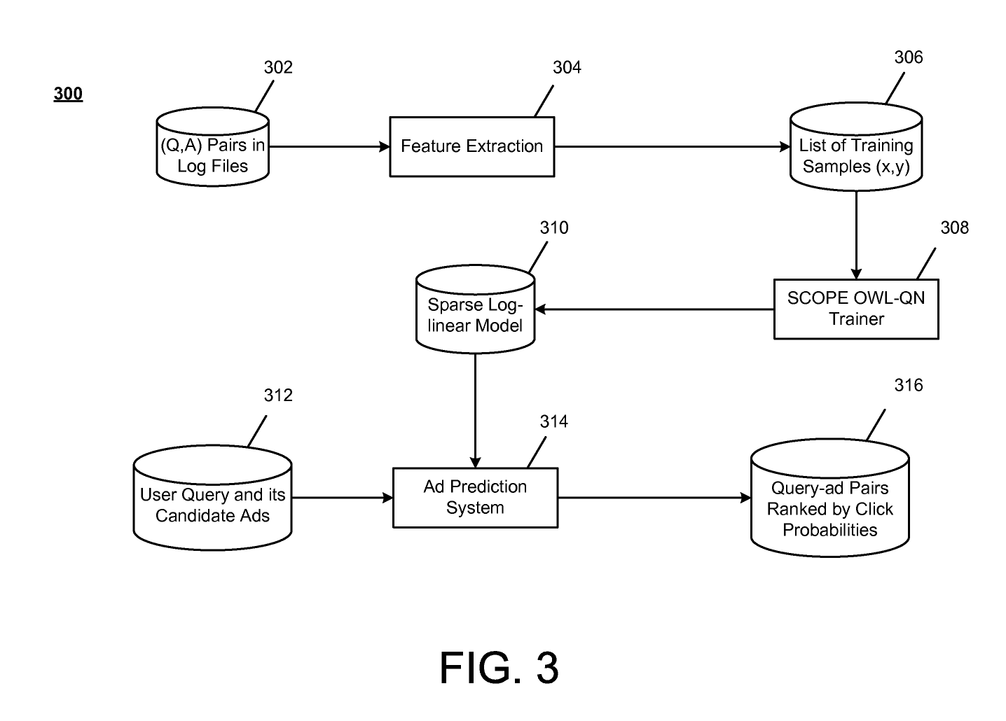

FIG. 3 is a block diagram of an example architecture for the system of FIG. 1. As shown in FIG. 3, a database 302 of log files may provide (Q, A) pairs as input to a feature extractor 304. The extracted features may be provided to a database 306 as lists of training samples (x,y). The training samples may be provided to a SCOPE OWL-QN trainer 308, which may train a sparse log-linear model 310, as discussed above.

A user query and its candidate ads 312 may be input to an ad prediction system 314, which may access the sparse log-linear model 310 to determine query-ad pairs ranked by click probabilities 316, as discussed above.

III. Flowchart Description

Features discussed herein are provided as example embodiments that may be implemented in many different ways that may be understood by one of skill in the art of data processing, without departing from the spirit of the discussion herein. Such features are to be construed only as example embodiment features, and are not intended to be construed as limiting to only those detailed descriptions.

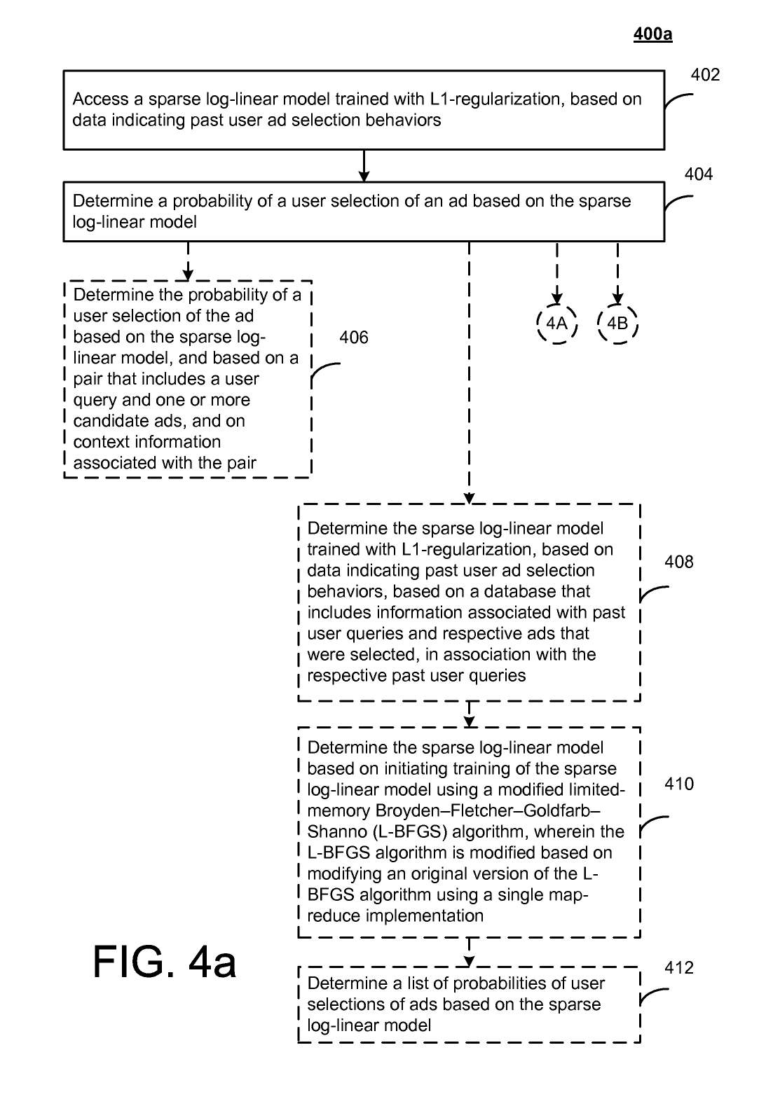

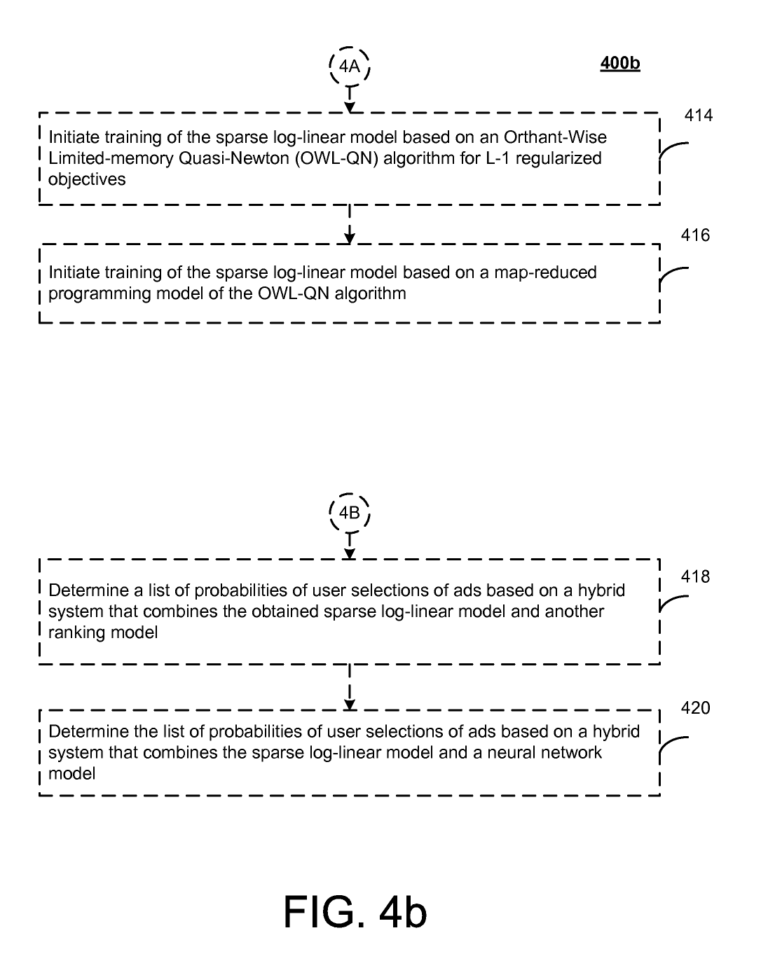

FIG. 4 is a flowchart illustrating example operations of the system of FIG. 1, according to example embodiments. In the example of FIG. 4a, a sparse log-linear model may be accessed (402). The model may be trained with L1-regularization, based on data indicating past user ad selection behaviors. For example, the model access component 108 may access the sparse log-linear linear model 110 trained with L1-regularization, based on data indicating past user ad selection behaviors, as discussed above.

A probability of a user selection of an ad may be determined based on the sparse log-linear model (404). For example, the prediction determination component 132 may determine a probability 134a, 134b, 134c of a user selection of an ad based on the sparse log-linear linear model 110, as discussed above.

For example, the probability of a user selection of the ad may be determined based on the sparse log-linear model, and based on a pair that includes a user query and one or more candidate ads, and on context information associated with the pair (406). For example, the prediction determination component 132 may determine the probability 134a, 134b, 134c of a user selection of the ad based on the sparse log-linear linear model 110, and based on a pair 144 that includes a user query 146 and one or more candidate ads 148, and on context information 150 associated with the pair 144, as discussed above.

For example, the sparse log-linear model trained with L1-regularization, based on data indicating past user ad selection behaviors, may be determined based on a database that includes information associated with past user queries and respective ads that were selected, in association with the respective past user queries (408). For example, the model determination component 136 may determine the sparse log-linear linear model 110, as discussed above.

For example, the sparse log-linear model may be determined based on initiating training of the sparse log-linear model using a modified limited-memory Broyden-Fletcher-Goldfarb-Shanno (L-BFGS) algorithm, wherein the L-BFGS algorithm is modified based on modifying an original version of the L-BFGS algorithm using a single map-reduce implementation (410).

For example, a list of probabilities of user selections of ads may be determined based on the sparse log-linear model (412). For example, the prediction determination component 132 may determine the list 140 of probabilities 134a, 134b, 134c of user selections of ads based on the sparse log-linear linear model 110, as discussed above.

For example, training of the sparse log-linear model may be initiated based on an Orthant-Wise Limited-memory Quasi-Newton (OWL-QN) algorithm for L-1 regularized objectives (414), in the example of FIG. 4b. For example, the model determination component 136 may initiate training of the sparse log-linear linear model 110 based on an Orthant-Wise Limited-memory Quasi-Newton (OWL-QN) algorithm 142 for L-1 regularized objectives, as discussed above.

For example, training of the sparse log-linear model may be initiated based on a map-reduced programming model of the OWL-QN algorithm (416). For example, the model determination component 136 may initiate training of the sparse log-linear linear model 110 based on a map-reduced programming model of the OWL-QN algorithm 142, as discussed above.

For example, a list of probabilities of user selections of ads may be determined based on a hybrid system that combines the obtained sparse log-linear model and another ranking model (418). For example, the prediction determination component 132 may determine the list 140 of probabilities of user selections of ads based on a hybrid system that combines the obtained sparse log-linear linear model 110 and another ranking model, as discussed above.

For example, the list of probabilities of user selections of ads may be determined based on a hybrid system that combines the sparse log-linear model and a neural network model (420). For example, the prediction determination component 132 may determine the list 140 of probabilities of user selections of ads based on a hybrid system that combines the sparse log-linear linear model 110 and a neural network model 160, as discussed above.

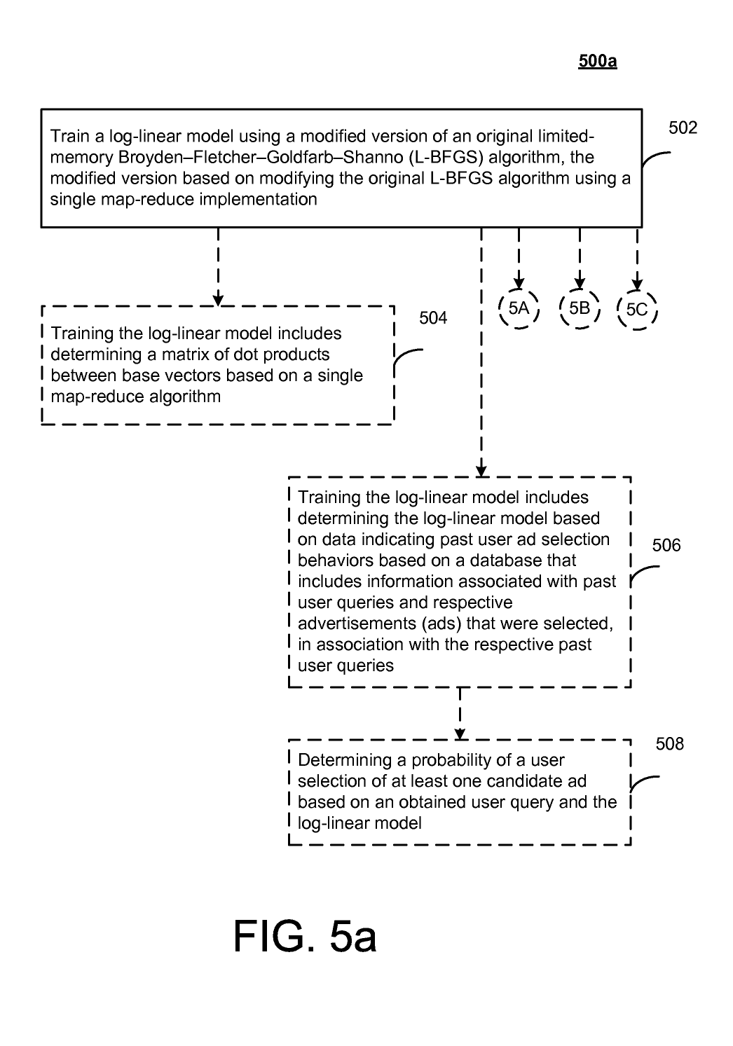

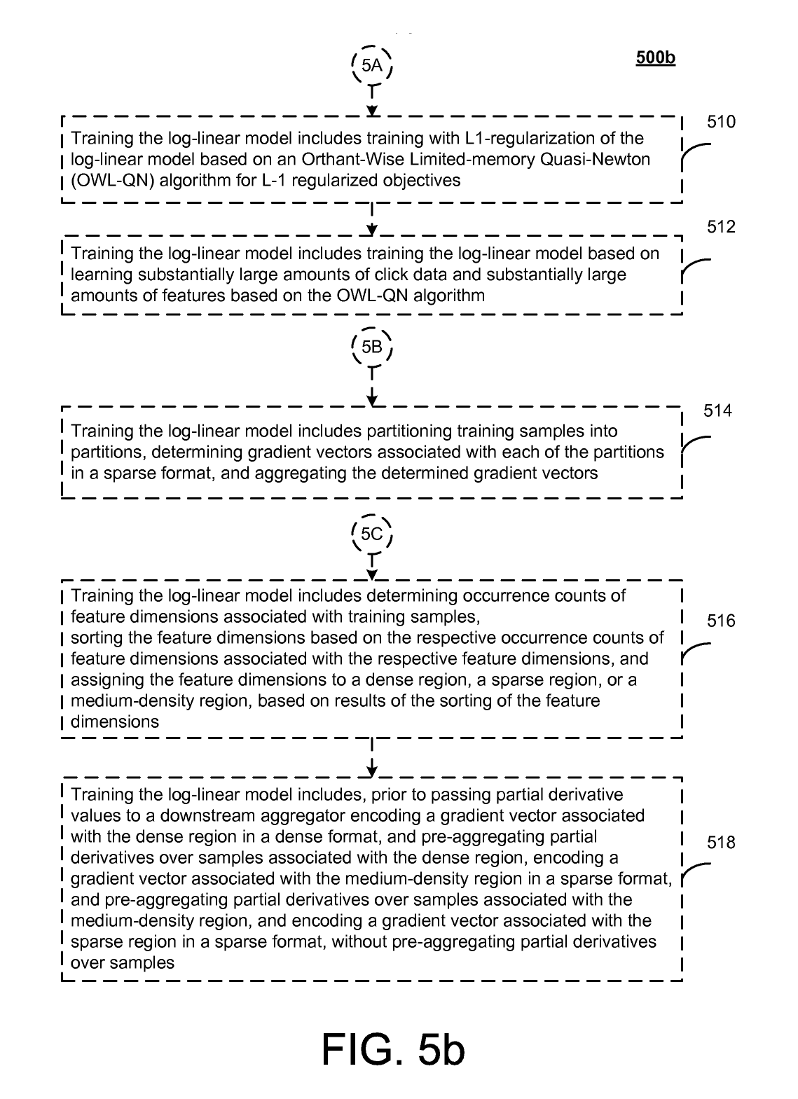

FIG. 5 is a flowchart illustrating example operations of the system of FIG. 1, according to example embodiments. In the example of FIG. 5a, a sparse log-linear model may be trained using a modified version of an original limited-memory Broyden-Fletcher-Goldfarb-Shanno (L-BFGS) algorithm (502). The modified version may be based on modifying the original L-BFGS algorithm using a single map-reduce implementation. For example, the model determination component 136 may be configured to determine the sparse log-linear model 110 based on initiating training of the sparse log-linear model 110 using a modified limited-memory Broyden-Fletcher-Goldfarb-Shanno (L-BFGS) algorithm 139, wherein the L-BFGS algorithm 139 is modified based on modifying an original version of the L-BFGS algorithm using a single map-reduce implementation, as discussed above.

For example, training the log-linear model may include determining a matrix of dot products between base vectors based on a single map-reduce algorithm (504), as discussed above.

A probability of a user selection of one or more candidate ads may be determined based on the sparse log-linear model and an obtained user query (504). For example, the prediction determination component 132 may determine a probability 134a, 134b, 134c of a user selection of an ad based on the sparse log-linear linear model 110, as discussed above.

One skilled in the art of data processing will understand that there are many applications other than ad prediction that may advantageously use sparse log-linear models, without departing from the spirit of the discussion herein.

For example, training the log-linear model may include determining the log-linear model based on data indicating past user ad selection behaviors based on a database that includes information associated with past user queries and respective advertisements (ads) that were selected, in association with the respective past user queries (506).

For example, a probability of a user selection of one or more candidate ads may be determined based on an obtained user query and the log-linear model (508).

For example, training the log-linear model may include training with L1-regularization of the log-linear model based on an Orthant-Wise Limited-memory Quasi-Newton (OWL-QN) algorithm for L-1 regularized objectives (510), in the example of FIG. 5b. For example, the model determination component 136 may initiate training of the log-linear linear model 110 based on the OWL-QN algorithm 142 for L-1 regularized objectives, as discussed above.

For example, training the log-linear model may include initiating training the log-linear model based on learning substantially large amounts of click data and substantially large amounts of features based on the OWL-QN algorithm (512).

For example, training the log-linear model may include partitioning training samples into partitions, determining gradient vectors associated with each of the partitions in a sparse format, and aggregating the determined gradient vectors (514).

For example, training the log-linear model may include determining occurrence counts of feature dimensions associated with training samples, sorting the feature dimensions based on the respective occurrence counts of feature dimensions associated with the respective feature dimensions, and assigning the feature dimensions to a dense region, a sparse region, or a medium-density region, based on results of the sorting of the feature dimensions (516).

For example, training the log-linear model may include, prior to passing partial derivative values to a downstream aggregator, encoding a gradient vector associated with the dense region in a dense format, and pre-aggregating partial derivatives over samples associated with the dense region, encoding a gradient vector associated with the medium-density region in a sparse format, and pre-aggregating partial derivatives over samples associated with the medium-density region, and encoding a gradient vector associated with the sparse region in a sparse format, without pre-aggregating partial derivatives over samples (518).

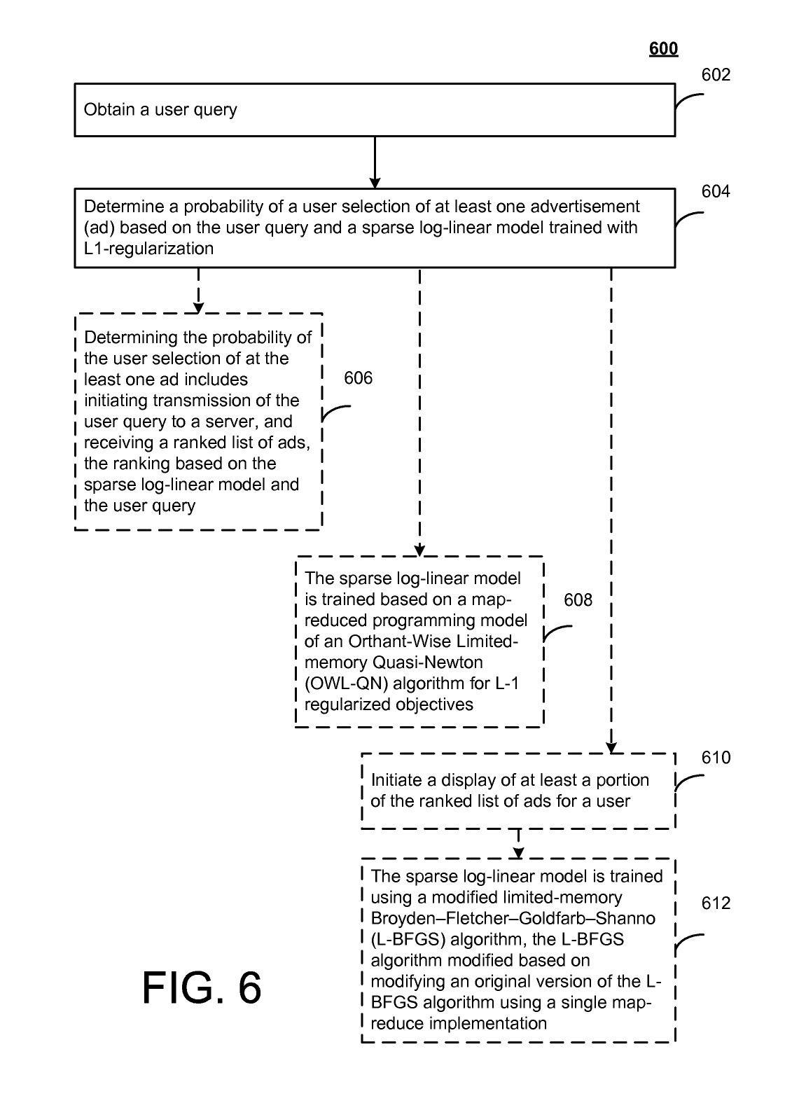

FIG. 6 is a flowchart illustrating example operations of the system of FIG. 1, according to example embodiments. In the example of FIG. 6a, a user query may be obtained (602). For example, the user query may be obtained via the query acquisition component 152, as discussed above.

A probability of a user selection of at least one advertisement (ad) may be determined, based on the user query and a sparse log-linear model trained with L1-regularization (604). For example, the prediction determination component 132 may determine a probability 134a, 134b, 134c of a user selection of an ad based on the sparse log-linear linear model 110, as discussed above.

For example, determining the probability of the user selection of at the least one ad may include initiating transmission of the user query to a server, and receiving a ranked list of ads, the ranking based on the sparse log-linear model and the user query (606).

For example, the sparse log-linear model may be trained based on a map-reduced programming model of an Orthant-Wise Limited-memory Quasi-Newton (OWL-QN) algorithm for L-1 regularized objectives (608), as discussed above.

For example, a display of at least a portion of the ranked list of ads may be initiated for a user (610).

For example, the sparse log-linear model may be trained using a modified limited-memory Broyden-Fletcher-Goldfarb-Shanno (L-BFGS) algorithm, the L-BFGS algorithm modified based on modifying an original version of the L-BFGS algorithm using a single map-reduce implementation (612), as discussed above.

One skilled in the art of data processing will understand that there are many ways of predicting user selections of ads, without departing from the spirit of the discussion herein.

Customer privacy and confidentiality have been ongoing considerations in data processing environments for many years. Thus, example techniques discussed herein may use user input and/or data provided by users who have provided permission via one or more subscription agreements (e.g., “Terms of Service” (TOS) agreements) with associated applications or services associated with queries and ads. For example, users may provide consent to have their input/data transmitted and stored on devices, though it may be explicitly indicated (e.g., via a user accepted text agreement) that each party may control how transmission and/or storage occurs, and what level or duration of storage may be maintained, if any.

Implementations of the various techniques described herein may be implemented in digital electronic circuitry, or in computer hardware, firmware, software, or in combinations of them (e.g., an apparatus configured to execute instructions to perform various functionality).

Implementations may be implemented as a computer program embodied in a pure signal such as a pure propagated signal. Such implementations may be referred to herein as implemented via a “computer-readable transmission medium.”

Alternatively, implementations may be implemented as a computer program embodied in a machine usable or machine readable storage device (e.g., a magnetic or digital medium such as a Universal Serial Bus (USB) storage device, a tape, hard disk drive, compact disk, digital video disk (DVD), etc.), for execution by, or to control the operation of, data processing apparatus, e.g., a programmable processor, a computer, or multiple computers. Such implementations may be referred to herein as implemented via a “computer-readable storage medium” or a “computer-readable storage device” and are thus different from implementations that are purely signals such as pure propagated signals.

A computer program, such as the computer program(s) described above, can be written in any form of programming language, including compiled, interpreted, or machine languages, and can be deployed in any form, including as a stand-alone program or as a module, component, subroutine, or other unit suitable for use in a computing environment. The computer program may be tangibly embodied as executable code (e.g., executable instructions) on a machine usable or machine readable storage device (e.g., a computer-readable storage medium). A computer program that might implement the techniques discussed above may be deployed to be executed on one computer or on multiple computers at one site or distributed across multiple sites and interconnected by a communication network.

Method steps may be performed by one or more programmable processors executing a computer program to perform functions by operating on input data and generating output. The one or more programmable processors may execute instructions in parallel, and/or may be arranged in a distributed configuration for distributed processing. Example functionality discussed herein may also be performed by, and an apparatus may be implemented, at least in part, as one or more hardware logic components. For example, and without limitation, illustrative types of hardware logic components that may be used may include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Processors suitable for the execution of a computer program include, by way of example, both general and special purpose microprocessors, and any one or more processors of any kind of digital computer. Generally, a processor will receive instructions and data from a read only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT), liquid crystal display (LCD), or plasma monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback. For example, output may be provided via any form of sensory output, including (but not limited to) visual output (e.g., visual gestures, video output), audio output (e.g., voice, device sounds), tactile output (e.g., touch, device movement), temperature, odor, etc.

Further, input from the user can be received in any form, including acoustic, speech, or tactile input. For example, input may be received from the user via any form of sensory input, including (but not limited to) visual input (e.g., gestures, video input), audio input (e.g., voice, device sounds), tactile input (e.g., touch, device movement), temperature, odor, etc.

Further, a natural user interface (NUI) may be used to interface with a user. In this context, a “NUI” may refer to any interface technology that enables a user to interact with a device in a “natural” manner, free from artificial constraints imposed by input devices such as mice, keyboards, remote controls, and the like.

Examples of NUI techniques may include those relying on speech recognition, touch and stylus recognition, gesture recognition both on a screen and adjacent to the screen, air gestures, head and eye tracking, voice and speech, vision, touch, gestures, and machine intelligence. Example NUI technologies may include, but are not limited to, touch sensitive displays, voice and speech recognition, intention and goal understanding, motion gesture detection using depth cameras (e.g., stereoscopic camera systems, infrared camera systems, RGB (red, green, blue) camera systems and combinations of these), motion gesture detection using accelerometers/gyroscopes, facial recognition, 3D displays, head, eye, and gaze tracking, immersive augmented reality and virtual reality systems, all of which may provide a more natural interface, and technologies for sensing brain activity using electric field sensing electrodes (e.g., electroencephalography (EEG) and related techniques).

Implementations may be implemented in a computing system that includes a back end component, e.g., as a data server, or that includes a middleware component, e.g., an application server, or that includes a front end component, e.g., a client computer having a graphical user interface or a Web browser through which a user can interact with an implementation, or any combination of such back end, middleware, or front end components. Components may be interconnected by any form or medium of digital data communication, e.g., a communication network. Examples of communication networks include a local area network (LAN) and a wide area network (WAN), e.g., the Internet.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A system comprising:
a device that includes at least one processor, the device including an advertisement (ad) prediction engine comprising instructions tangibly embodied on a computer readable storage medium for execution by the at least one processor, the ad prediction engine including:
a model access component configured to access a sparse log-linear model trained with L1-regularization, based on data indicating past user ad selection behaviors; and
a prediction determination component configured to determine a probability of a user selection of an ad based on the sparse log-linear model.

2. The system of claim 1, wherein:
the prediction determination component is configured to determine the probability of a user selection of the ad based on the sparse log-linear model, and based on a pair that includes a user query and one or more candidate ads, and on context information associated with the pair.

3. The system of claim 1, further comprising:
a model determination component configured to determine the sparse log-linear model trained with L1-regularization, based on data indicating past user ad selection behaviors, based on a database that includes information associated with past user queries and respective ads that were selected, in association with the respective past user queries.

4. The system of claim 3, wherein:
the model determination component is configured to determine the sparse log-linear model based on initiating training of the sparse log-linear model using a modified limited-memory Broyden-Fletcher-Goldfarb-Shanno (L-BFGS) algorithm, wherein the L-BFGS algorithm is modified based on modifying an original version of the L-BFGS algorithm using a single map-reduce implementation; and
the prediction determination component is configured to determine a list of probabilities of user selections of ads based on the sparse log-linear model.

5. The system of claim 1, further comprising:
a model determination component configured to initiate training of the sparse log-linear model based on an Orthant-Wise Limited-memory Quasi-Newton (OWL-QN) algorithm for L-1 regularized objectives.

6. The system of claim 5, wherein:
the model determination component is configured to initiate training of the sparse log-linear model based on a map-reduced programming model of the OWL-QN algorithm.

7. The system of claim 1, wherein:
the prediction determination component is configured to determine a list of probabilities of user selections of ads based on a hybrid system that combines the obtained sparse log-linear model and another ranking model.

8. The system of claim 7, wherein:
the prediction determination component is configured to determine the list of probabilities of user selections of ads based on a hybrid system that combines the sparse log-linear model and a neural network model.

9. A method comprising:
training a log-linear model using a modified version of an original limited-memory Broyden-Fletcher-Goldfarb-Shanno (L-BFGS) algorithm, the modified version based on modifying the original L-BFGS algorithm using a single map-reduce implementation.

10. The method of claim 9, wherein:
training the log-linear model includes determining a matrix of dot products between base vectors based on a single map-reduce algorithm.

11. The method of claim 9, wherein:
training the log-linear model includes determining the log-linear model based on data indicating past user ad selection behaviors based on a database that includes information associated with past user queries and respective advertisements (ads) that were selected, in association with the respective past user queries; and wherein
the method further comprises:
determining, via a device processor, a probability of a user selection of one or more candidate ads based on an obtained user query and the log-linear model.

12. The method of claim 9, wherein:
training the log-linear model includes training with L1-regularization of the log-linear model based on an Orthant-Wise Limited-memory Quasi-Newton (OWL-QN) algorithm for L-1 regularized objectives.

13. The method of claim 12, wherein:
training the log-linear model includes training the log-linear model based on learning substantially large amounts of click data and substantially large amounts of features based on the OWL-QN algorithm.

14. The method of claim 9, wherein:
training the log-linear model includes:
partitioning training samples into partitions,
determining gradient vectors associated with each of the partitions in a sparse format, and
aggregating the determined gradient vectors.

15. The method of claim 9, wherein:
training the log-linear model includes:
determining occurrence counts of feature dimensions associated with training samples,
sorting the feature dimensions based on the respective occurrence counts of feature dimensions associated with the respective feature dimensions, and
assigning the feature dimensions to a dense region, a sparse region, or a medium-density region, based on results of the sorting of the feature dimensions.

16. The method of claim 15, wherein:
training the log-linear model includes, prior to passing partial derivative values to a downstream aggregator:
encoding a gradient vector associated with the dense region in a dense format, and pre-aggregating partial derivatives over samples associated with the dense region,
encoding a gradient vector associated with the medium-density region in a sparse format, and pre-aggregating partial derivatives over samples associated with the medium-density region, and
encoding a gradient vector associated with the sparse region in a sparse format, without pre-aggregating partial derivatives over samples.

17. A computer program product tangibly embodied on a computer-readable storage medium and including executable code that causes at least one data processing apparatus to:
obtain a user query; and
determine, via a device processor, a probability of a user selection of at least one advertisement (ad) based on the user query and a sparse log-linear model trained with L1-regularization.

18. The computer program product of claim 17, wherein:
determining the probability of the user selection of at the least one ad includes:
initiating transmission of the user query to a server, and
receiving a ranked list of ads, the ranking based on the sparse log-linear model and the user query.

19. The computer program product of claim 17, wherein:
the sparse log-linear model is trained based on a map-reduced programming model of an Orthant-Wise Limited-memory Quasi-Newton (OWL-QN) algorithm for L-1 regularized objectives.

20. The computer program product of claim 18, wherein the executable code is configured to cause the at least one data processing apparatus to:
initiate a display of at least a portion of the ranked list of ads for a user, wherein
the sparse log-linear model is trained using a modified limited-memory Broyden-Fletcher-Goldfarb-Shanno (L-BFGS) algorithm, the L-BFGS algorithm modified based on modifying an original version of the L-BFGS algorithm using a single map-reduce implementation.
